(19) United States
(12) Patent Application Publication
(10) Pub. No.: US 2010/0038022 A1
(43) Pub. Date: Feb. 18, 2010

(54) MACHINE FOR DECORATING OBJECTS AND METHOD THEREOF

(76) Inventor: Marco Lapelosa, Modena (IT)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/448,726

(22) PCT Filed: Jan. 3, 2008
(86) PCT No.: PCT/IT2008/000008

§ 371 Date: Oct. 20, 2009

(30) Foreign Application Priority Data
Jan. 4, 2007 (IT) PCT/IT2007/000007

(51) Int. Cl. B44C 1/16; B32B 37/10

(52) U.S. Cl. 156/238; 156/382

(57) ABSTRACT

A machine for decorating objects (1, 17, 36) having any shape whatsoever, comprising: a decoration plane on which the object to be decorated is placed; a decoration device (7, 51) with a component made of a thin, elastic and flexible material on which an image of the decoration is generated; a pressure device for deforming said component in flexible material to make it adhere, together with the decoration of the image, to the curved surface of the object to be decorated, acting with greater pressure on the back of said component in flexible material with respect to the pressure applied to the surface with the image; characterised in that the object to be decorated (1, 17, 36) is transported on a conveyor belt (2, 16, 22, 32, 35, 45) into the machine from the loading area (4) to the decoration area (6, 37) and then to the unloading area (5); furthermore, the component in flexible material is a thin, elastic and flexible tape (3), stretched over transport and rolling organs is positioned at a short distance from the object to be decorated in the decoration area (6, 37), and provides a surface (10), on which the image of the decoration to be applied has been generated or transferred; in the idle position said conveyor belt and tape are kept at a predetermined distance (D) which is greater than the maximum height of the objects (1, 17, 36) to be decorated; decoration is carried out in the decoration area by pressure being applied by said device to the back of the thin, elastic and flexible tape (3) to deform it and is complete when the deformation of the tape is released. Various embodiments and different operation and decoration cycles are described.

### TECHNICAL FIELD

The present invention relates to a machine for decorating objects of any shape whatsoever, even flat or level, with convex and/or concave edges, borders, corners, or curves in general, even only on part of their external surfaces and which, as is well-known, are difficult to decorate. Among these objects are, particularly, special pieces for completion of ceramic tiles and surfaces covered with them, such as skirting-boards, angular elements, borders, steps, as well as connecting elements between floor and wall. The invention further relates to the method for transferring an image from the printing means where it is contained to the object to be decorated.

### PRIOR ART

Various devices for printing and/or decorating are known in the prior art. In the ceramic industry a great number of devices, methods, printing and decorating machines have been adopted to speed up production, comprising silkscreen printing, pad printing and flexography, where the image is contained in a cliché or screen or it is engraved on a surface which is filled with colour, smoothed and, when passed over the object, it leaves drops of colour to form the desired decoration; moreover, the drops can be distributed using inkjet technology. Furthermore, in the ceramic industry, given the difficulty of positioning the means for transferring the image from the roller or screen, which are never sufficiently flexible to reach the convex or concave curves, the cavities or concave shapes present in said special pieces for completion of ceramic tile surface coverings, spray decoration techniques, also automatic, have been developed, as well as with image transfer like decalcomania by means of an intermediary flexible sheet on to which the image is transferred by printing, silkscreen printing or inkjet, and then positioned by hand on to the object to be decorated in such a way that the ink, already dry, can be placed on it.

However, in this way, decoration of the special completion elements for surfaces covered with tiles requires intervention by hand so penalizing the cost of the finished product and, unlike the tile with which it matched, providing a decoration which only rarely is indistinguishable from the decoration of said tile. In fact, as is known, the tile is decorated by means of an automatic line while the special element, as mentioned above because of its curved shape, is decorated by means of other methods: spraying, manual decoration, ink transfer decoration with decalcomania or even with previous colouring of the material used for the tile so as to produce a resemblance as close as possible to the tile.

Furthermore, the objects to be decorated using the known art, especially in the field of ceramic tiles, can be extremely fragile since the decoration is carried out before firing; this is the case of objects which are monocotto, i.e. they undergo single firing. In this way, the object to be decorated, if it is flat or almost flat and the decoration is applied to a level surface, can easily be decorated with the various mechanical methods known in the prior art, while in the presence of curved surfaces, as mentioned above, decoration can only be carried out by previous colouring of the material, by spraying, by manual decalcomania transfer or by hand, using a brush or sponge.

The known art also includes automatic apparatus or machines which carry out the decoration rapidly but only on objects which, like tiles, are level; they are provided with rollers on which a silk screen or a partially flexible dot-engraved surface is placed but these are not sufficiently flexible to reach the curved edges of the tiles and special elements currently in production.

The known art also includes the registered patent application EP 0 495 111 A1 which describes a single-station machine where the three-dimensional object to be decorated is placed on a decoration plane in a closed environment with air suction or pressure created by an elastic membrane being pressed onto the object from above, so an image is transferred by a tape that is positioned between said upper membrane under pressure and the object below; so as to concentrate the flexibility in the elastic membrane. The transfer is achieved by heating the tape and thereby the image to be transferred or if necessary with the help of an adhesive sprayed onto the image to be transferred before it comes into contact with the object to be decorated.

However, such a machine has drawbacks if it is not required for use with limited productions, as it is difficult to speed up the operating steps of the machine. Therefore the use of the machine described above is not suitable in the field of semi-finished products for tiles, where large quantities of objects must be decorated and often also have decorations that are different from each other.

Furthermore, the known art includes the patent EP 1 509 401 B1 which describes a single-station machine for the decoration of objects where the object is supported by a transport device and is pressed against a flexible membrane, which has the image to be transferred on it. The membrane in turn is supported by a pressure chamber to support its deformation. It is positioned close to the object to be decorated and has a backing support made of a deformable and/or compressible material: in this way the flexibility for completely decorating the three-dimensional object is shared by two components, i.e. the elastic membrane and the deformable backing support.

Such a machine also has the drawback of not being able to speed up its operating steps: in fact, the synchronous motion of the object and backing support with the pressure chamber means that the machine has to be operated discontinuously, that is, switched off for timed intervals. Therefore the use of the machine described above is not suitable in the field of semi-finished products for tiles, either for producing large quantities of objects with continuous action during decoration, or for use with materials that are still fragile.

### SUMMARY OF THE INVENTION

The technical problem at the base of the present invention is to provide a decoration machine that is economical for limited productions, but also capable of reaching high production levels. Higher productivity, if not obtained to the detriment of the final quality (i.e. with a good level of decoration), is a further difficulty in solving the technical problem of the machine carrying out the decoration method.

A further object of the invention is to provide a machine which makes it possible to apply the decoration method also to objects which are still fragile, such as tiles or their special parts which are already formed but not yet fired.

A further last but not least object of the present invention is to provide a machine which works constantly for economical operation in serial production, i.e. providing a machine with continuously-fed production lines to decorate objects continuously.

Further still, it is necessary to provide a decoration method which makes it possible to reach all the curved surfaces, convex or concave, present in the objects to be decorated, in particular the special elements for completion of coverings with ceramic tiles, and that has a particularly delicate decorating action so that it can be used on objects that are still fragile.

These problems are solved, according to the present invention, by a machine for decorating objects having any shape whatsoever, comprising: a decoration plane on which the object to be decorated is placed; a decoration device with a component made of a thin, elastic and flexible material on which an image of the decoration is generated; a pressure device for deforming said component in flexible material to make it adhere, together with the decoration of the image, to the curved surface of the object to be decorated, acting with greater pressure on the back of said component in flexible material with respect to the pressure applied to the surface with the image; characterised in that the object to be decorated is transported on a conveyor belt into the machine from the loading area to the decoration area and then to the unloading area; furthermore, the component in flexible material is a thin, elastic and flexible tape stretched over transport and rolling organs, is positioned at a short distance from the object to be decorated in the decoration area and provides a surface on which the image of the decoration to be applied has been generated or transferred; in the idle position said conveyor belt and tape are kept at a predetermined distance which is greater than the maximum height of the objects to be decorated; decoration is carried out in the decoration area by pressure being applied by said device to the back of the thin, elastic and flexible tape to deform it and is complete when the deformation of the tape stops.

In a further embodiment, the machine is provided with a pressurising device composed of a chamber in the decoration area, of which the thin, elastic and flexible tape forms at least one wall and where pressure is applied to the back of said tape; said chamber is provided with lateral and longitudinal containment means for the deformed tape in order to minimise loss of the compressed air blown into the chamber pressurised in this way; the decoration cycle is thus intermittent to the object being introduced and stopped in the decoration area.

In a preferred embodiment, the machine is provided with a pressurising device composed of air suction organs around the object in the decoration area with suction capacity such as to deflect the thin, elastic and flexible tape so as to make it adhere, by means of the atmospheric pressure on the back of it, to the surface of the object to be decorated for the amount of time required for the cycle, if the cycle is discontinuous or intermittent, or for the time required for the object to pass through the decoration area, if the decoration cycle is continuous.

In a further embodiment, the machine is provided with the conveyor belt or at least its intermediary central strip in semi-permeable material so as to permit air suction through said conveyor belt.

In a preferred embodiment, the machine is further provided with the conveyor belt composed of a tape in thin, elastic and flexible material with holes near the centre, intended to correspond with suction organs placed on the surface of the conveyor belt and around the decoration area; it further provides the conveyor belt, in thin, elastic and flexible material, with a semi-permeable central strip in order to permit suction at least within the width of the strip.

In yet a further embodiment, for fragile materials, the machine is further provided with the conveyor belt composed of a tape in thin, elastic and flexible material in which holes have been made, intended to correspond with suction organs placed on the surface of the conveyor belt and around the decoration area; it further provides the conveyor belt in thin, elastic and flexible material with several adjacent longitudinal rows of holes, in order to permit suction at least within the width of the strip occupied by the adjacent rows of holes.

In a further and preferred embodiment, the machine is further provided with the conveyor belt composed of a tape in thin, elastic and flexible material with suction organs placed between the conveyor belt and the tape and in synchronous motion with them; it is further provided with the conveyor belt in thin, elastic and flexible material with a semi-permeable central strip in order to permit suction at least within the width of the strip; said suction organs being supported by a device to move them forward with the conveyor belt and tape and positioned with the suction end inside the semi-permeable central strip between said conveyor belt and said tape in thin, elastic and flexible material.

In a preferred embodiment the machine is further provided with said suction organs positioned between the conveyor belt and the tape and supported by a device for moving them forward with the conveyor belt and the tape and positioned with the suction ends near the decoration area; the forward movement device being composed of a vacuum-tight conveyor belt on pairs of pulleys at each end, which unites the ends of the suction organs outside the tapes and connects them to the internal space between the pulleys in order to apply the vacuum to said suction organs.

In a further embodiment, the machine provides the application of the vacuum to the external ends of the suction organs, controlled and regulated by a splitter septum which can be modified in the area where suction starts and ends, in such a way as to start or end suction as is necessary in said suction organs, depending on the position reached by them in relation to the object decoration area.

In a preferred embodiment, the machine is further provided with the conveyor belt composed of a tape in thin, elastic and flexible material with suction organs placed between the conveyor belt and the tape; it is further provided with the conveyor belt in thin, elastic and flexible material with at least one semi-permeable central strip, to permit suction at least within the width of the strip; said suction organs being present on at least one side and positioned with the suction end on the edge of the semi-permeable central strip between said conveyor belt and said tape in thin, elastic and flexible material.

In a preferred embodiment, the machine has a decoration device comprising organs for the generation or transfer of wax decalcomania that include a heating device for transfer to the thin, elastic and flexible tape.

In a further embodiment, the machine is provided with said decoration device which comprises containment organs that slide from an external position, for holding the image on a surface with a layer of wax, generated or transferred onto it, and an internal position, for transferring the image onto the thin, elastic and flexible tape; or, is provided with said decoration device which comprises image storage and distribution organs provided with a tape with the images to be transferred, stretched between winding and unwinding reels, and pressed against the surface of the thin, elastic and flexible tape for the transfer of the image onto it.

The technical problems are also solved, according to the present invention, by a method for transferring images also to the curved surfaces of objects to be decorated, comprising generation and/or transfer of the image, using a method known in the art, onto a thin elastic and flexible intermediary transfer surface; characterised in that said transfer surface is made of a thin, elastic and flexible tape, which during the decoration process is placed at a short distance from the object to be decorated; said thin, elastic and flexible tape provides the image made to adhere to the object to be decorated by means of overpressure of the air applied to the back of it and therefore the surface with the image to be transferred; the object to be decorated moves synchronously on a conveyor belt with said thin, elastic and flexible tape, discontinuously or continuously depending on the method used for generating and/or transferring the image.

With a further operating method, the objects to be decorated are transported from the loading area to the decoration and unloading areas by the conveyor belt which acts as a cooperating organ for the application of the overpressure to the back of the thin, elastic and flexible tape.

With a different operating method, the objects to be decorated are transported from the loading area to the decoration and unloading areas by the conveyor belt but the application of overpressure applied to the back of the thin, elastic and flexible tape is achieved by means of the suction organs that are placed between the conveyor belt and the tape.

### BRIEF DESCRIPTION OF THE DRAWINGS

FIG. 1 represents a longitudinal schematic view of a decoration machine with discontinuous or continuous operation, according to a first embodiment of the present invention.

FIG. 2 further represents a schematic transversal view of the machine in FIG. 1 above.

FIG. 3 further represents a longitudinal schematic view of a machine with continuous operation for decorating fragile objects, according to a second embodiment of the present invention.

FIG. 4 further represents a transversal schematic view of the machine in FIG. 3 above.

FIG. 5 further represents a longitudinal schematic view of a machine for decorating fragile objects with an improved suction plane, according to a third embodiment of the present invention.

FIG. 6 further represents a transversal schematic view of the machine in FIG. 5 above.

FIG. 7 further represents a longitudinal schematic view of a machine for decorating even fragile objects, with suction carried out by mobile means with the conveyor belts, according to a fourth embodiment of the present invention.

FIG. 8 further represents a transversal schematic view of the machine in FIG. 7 above.

FIG. 9 yet further represents a longitudinal schematic view enlarged IX of the mobile suction means in FIG. 8.

FIG. 10 further represents a transversal schematic view enlarged X of the start-up device of the mobile suction means in FIG. 8.

FIG. 11 yet further represents a longitudinal schematic view of an intermittent pressure operating machine for decorating objects even very large objects, according to a fifth embodiment of the present invention.

FIG. 12 further represents, a transversal schematic view of the machine in FIG. 11 above.

FIG. 13 yet further represents a longitudinal schematic view of a machine for decorating objects provided with a different device for the application of the vacuum between the conveyor belt and the tape, with suction blades, according to other previous embodiments of the present invention.

FIG. 14 represents a schematic plan view along the XIV plane of FIG. 13 of the vacuum-tight space between the conveyor belt and the tape achieved by the suction blades.

FIG. 15 further represents a transversal schematic view of the machine in FIG. 13 above and FIG. 15b represents an enlargement of the vacuum-tight space between the conveyor belt and tape and one of the blades.

FIG. 16 yet further represents a longitudinal schematic view of a machine for decorating objects, according to a further embodiment of the present invention, which uses an intermittent-cycle decalcomania image transfer method, provided with a device for applying the vacuum in the space between the conveyor belts and tape with the suction blades.

FIG. 17 further represents a transversal schematic view of the machine in FIG. 16 above, complete with the positions taken by the decalcomania image transfer containment organ and FIG. 17b represents an enlargement of the space between the conveyor belt and tape with the insertion of a suction blade.

FIG. 18 yet further represents a longitudinal schematic view of a machine for decorating objects using the decalcomania image generation method with continuous motion cycles, provided with a vacuum application device with suction blades, for creating a vacuum in the space between the conveyor belt and the tape.

FIG. 19 further represents a transversal schematic view of the machine in FIG. 18 above and FIG. 19b represents an enlargement of the suction space between the conveyor belt and the tape.

### DETAILED DESCRIPTION OF SOME PREFERRED EMBODIMENTS

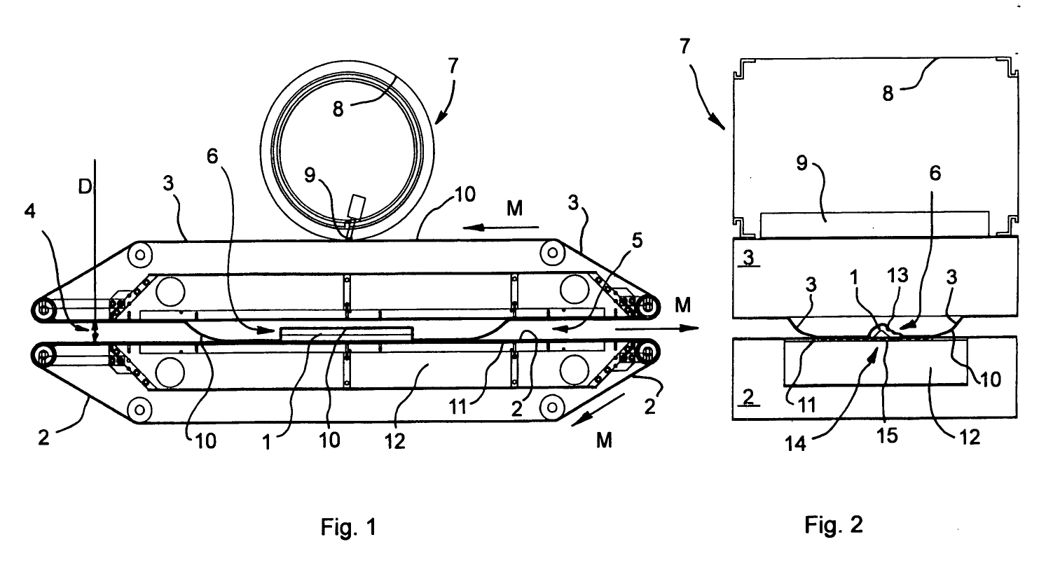

The object decoration machine 1, in FIGS. 1 and 2, is composed of a conveyor belt 2 with intermittent motion synchronous with the step for generating the image on the surface of an upper tape 3, placed at a predetermined distance D, so as to position the objects 3 from the loading 4 and unloading 5 areas to and from the decoration area 6. The decorating means 7, are illustrated as a silkscreen roller 8 with internal doctor knife 9, and they operate according to the known art for generating an image on the surface 10 of the upper tape 3, advantageously in elastic, flexible material such as soft silicone. The distance D is greater than the maximum height of the objects 1 placed on the conveyor belt plane 2, in such a way that the tape and the conveyor belt can move synchronously but the object 1 only comes into contact with the upper tape 3 in the decoration area 6 and only during the decoration process. The object 1 is carried forward by the conveyor belt 2 from the loading area 4 towards the decoration area 6; once it has reached the limits of the decoration area, the conveyor belt plane 11 has an air suction device 12 surrounding the object to be decorated 1: suction causes flexion of the upper flexible tape 3, in soft silicone, which bears on its surface 10 the image generated by the decoration means 7. Movement of the tape and conveyor belt 2 and 3 is continuous or intermittent, and advantageously synchronous in such a way that flexion of the upper tape 3 starts at the beginning of the decoration area 6 and continues for its entire length. Therefore, the image is transferred rapidly, so eliminating the possibility of slipping or deformation of the decoration on the visible surface 13 of the object 1, given the synchronous movement of the tape and conveyor belt. In order to improve positioning, transporting and suction operations, the lower conveyor belt 2 is advantageously covered with a permeable or semi-permeable material, at least in its central strip 14. A holed suction device 15 is present in the central strip, connected to a vacuum generation device suitably powerful for the size of the decoration area 6 and the flexing resistance of the upper tape 3 in soft silicone. The decoration machine operates with an intermittent or continuous cycle, in fact, when the object 3 reaches the end of the decoration area 6, vacuum application is released, whether the machine is being used with a discontinuous or continuous operation cycle, so releasing the upper tape 3 which is rapidly detached from the visible surface 13 of the object.

Even if not explicitly described, in all the embodiments illustrated with intermittent or continuous operation, cleaning means are present operating on the basis of the intermittent or continuous operation of the invention embodiment. Therefore, motorization means are provided for the conveyor belts and decoration flexible tapes, as well as any other part even if only intermittent, even if not explicitly mentioned as it forms part of the knowledge of the average person skilled in the art of this sector.

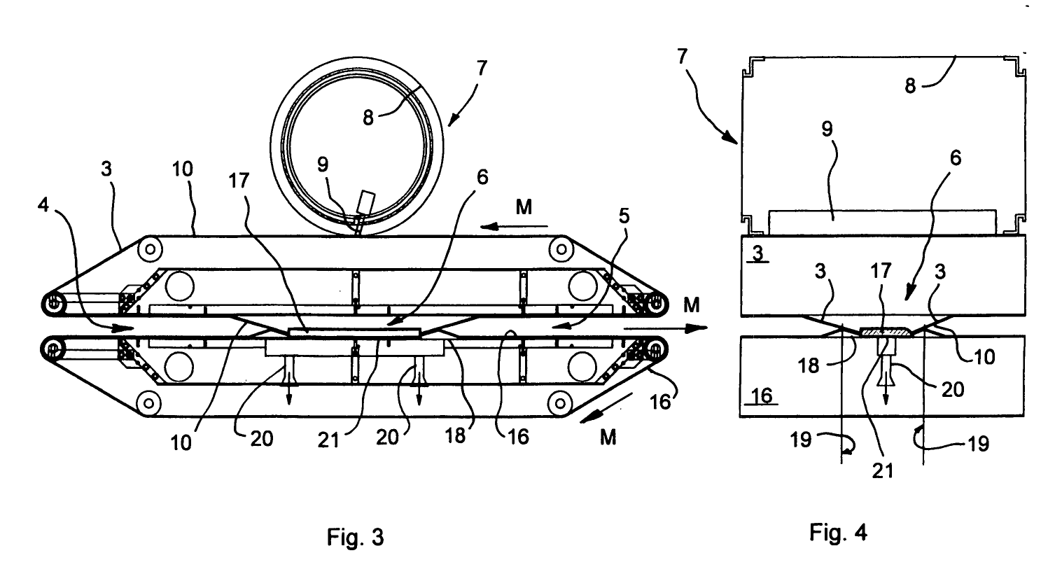

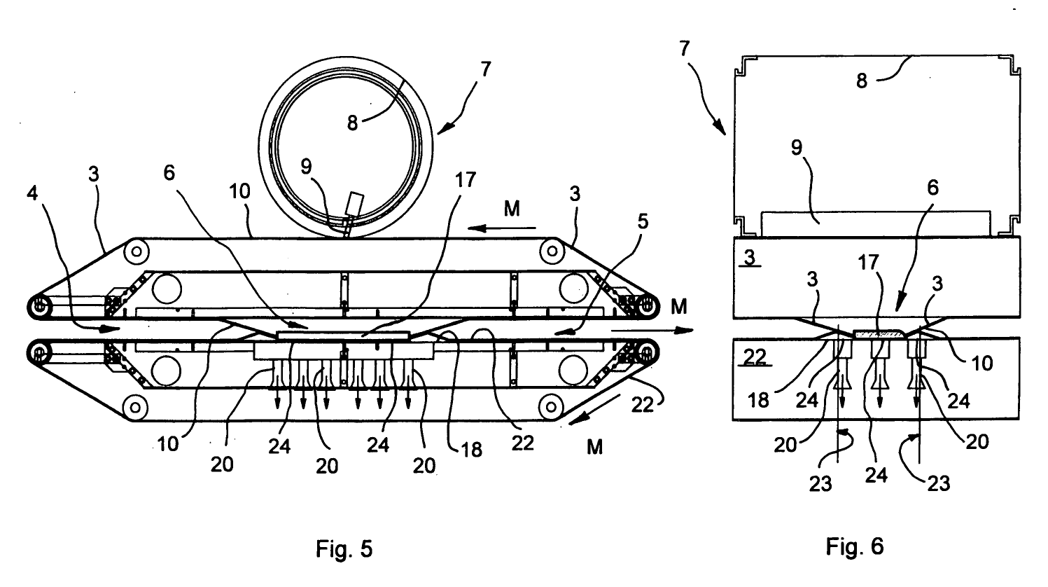

FIGS. 3 to 6 illustrate a second and third embodiment for decorating fragile materials, other than the technical means already mentioned for the first embodiment, where a continuous motion flexible conveyor belt 16 is visible, operating synchronously with the step for generating an image on the surface 10 of an upper tape 3, placed at a predetermined distance, for positioning the objects 17 from the loading 4 and unloading 5 area to and from the decoration area 6. Similarly to the first embodiment, application of the vacuum takes place from the surface 18 of the flexible conveyor belt 16, advantageously in soft silicon, on which there is a central row of holes in the second embodiment, in FIGS. 3 and 4, and parallel rows of holes in a central area as can be seen in FIGS. 5 and 6 of the third embodiment. FIG. 4 shows the central area 19 where the suction devices 20 are arranged in a single row, corresponding to the single row of holes present in the flexible conveyor belt 16 and a corresponding slot 21 or row of holes in the surface 18 and sliding of the conveyor belt 16, advantageously in soft silicone. Given the tendency to apply suction between the tape and conveyor belt in silicone, the central area 19 of the lower conveyor belt 16 is covered with a strip of partially permeable material, in order to permit application of the vacuum to the surface of the tape.

In the third embodiment the conveyor belt 22 with several rows of holes in the central area 23 makes it possible to avoid the strip in partially permeable material and, therefore, to avoid greater difficulty in cleaning the flexible conveyor belt from the residues of colour compared to the second embodiment. The rows of holes correspond with a plane 18 with slots 24 or rows of holes for suction with different spacing with respect to the holes in the tape 22.

In these two last embodiments, decoration takes place in such a way as not to damage the fragile objects to be decorated: in fact, not only is the upper tape 3 flexible but also the lower conveyor belt 16 or 22 is flexible so as to avoid stress on the object which could cause cracking or breaking of the object to be decorated if it is fragile. Obviously, these embodiments can also be used for more resistant objects, while the opposite is not possible since the machine in the first embodiment, FIGS. 1 and 2, with a rigid conveyor belt surface 2, easily causes stress on the object with the deformation of the upper flexible tape 3.

Furthermore, the presence of a central strip 14, 19 or 23 subject to suction both with a partially permeable surface and with a strip with several rows of holes, makes it possible to decorate objects 1, 17 arranged in several rows inside the width of the strips 14, 19 or 23 so as to increase the decoration capacity of the machine.

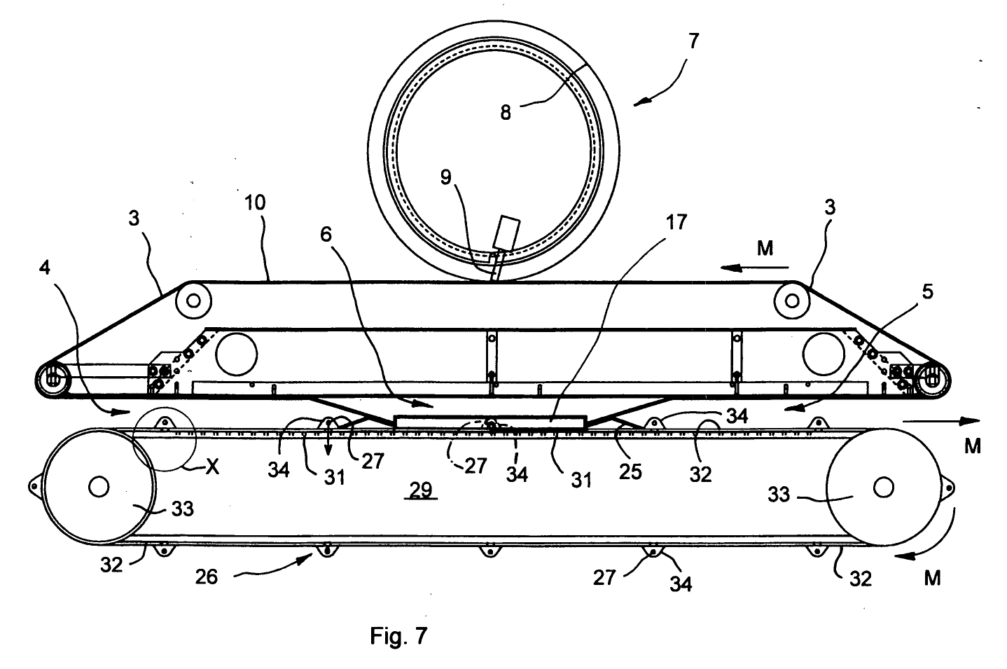

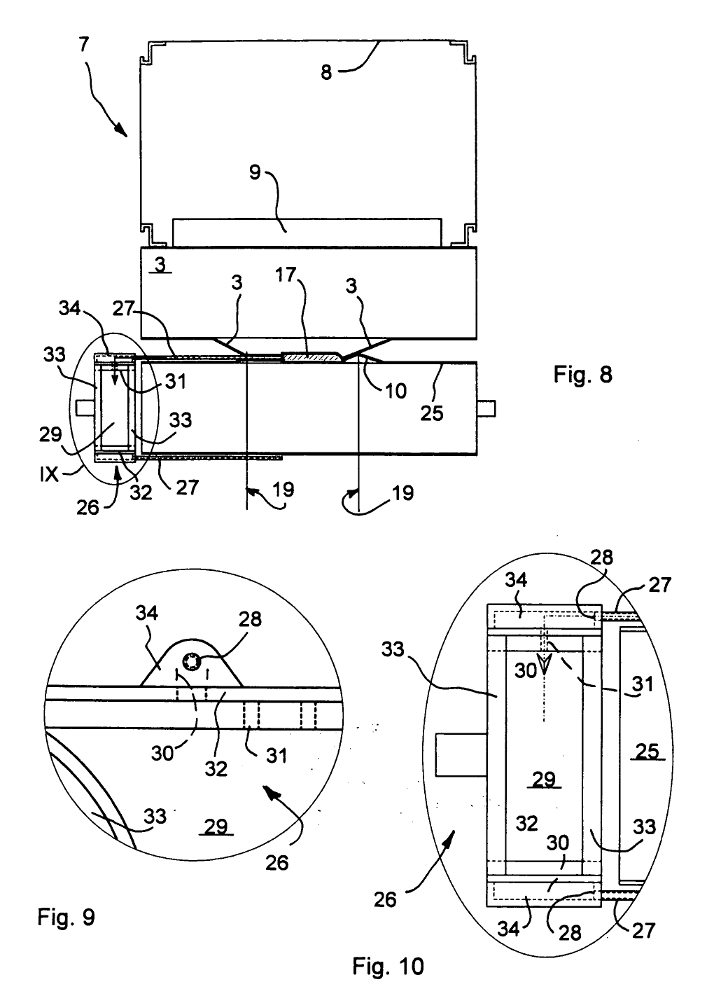

A further embodiment, the fourth of the invention, for fragile materials to be decorated, illustrated in FIGS. 7 and 8, regards a computer-based machine provided with a flexible conveyor belt 25 with continuous motion synchronous with the step for generating an image on the surface 10 of an upper tape 3, placed at a predetermined distance, for positioning the objects from the loading 4 and unloading 5 areas to and from the decoration area 6. Unlike the previous embodiments, application of the vacuum takes place by means of a horizontal carousel conveyor 26 of suction means 27 with motion synchronized with the lower flexible conveyor belt 25. Said suction means, in the simplest form, can be formed of tubes 27 which extend, with the external ends, inside the central area 19 of the conveyor belt 25, advantageously covered in partially permeable material so as to permit complete suction of the air inside the strip occupied by the partially permeable material.

FIGS. 9 and 10 show, furthermore, the ends 28 of the tubes 27 inside the carousel conveyor 26, as they face the internal space 29 in a vacuum, when air suction is necessary, and with their openings 30 placed on a splitter septum 31 for controlling air suction synchronous with the position reached on the conveyor belt plane 25; the carousel conveyor is composed of a vacuum-tight conveyor belt 32 wound on pulleys 33 also vacuum-tight. Each tube 27 is connected to the vacuum-tight conveyor belt 32 by means of a head 34, so that as the head passes over the septum 31 a vacuum is applied inside the tube which applies it to the other end of the central area 19 where the object to be decorated 17 is present. The decoration operation takes place similarly to the previous embodiments with flexion of both the upper tape 3 and the conveyor belt 25, but with the simplification of not having holed planes or holed tapes but with suction tubes 27 placed between the conveyor belt and the tape in the central decoration area 6. Finally, the presence of the septum 31, which can be partialized as desired by obstructing the holes on the internal side facing the internal space 29 in a vacuum, makes it possible to considerably reduce the volume of air intake only in the areas which are strictly necessary, so as to reduce the energy consumption of the machine.

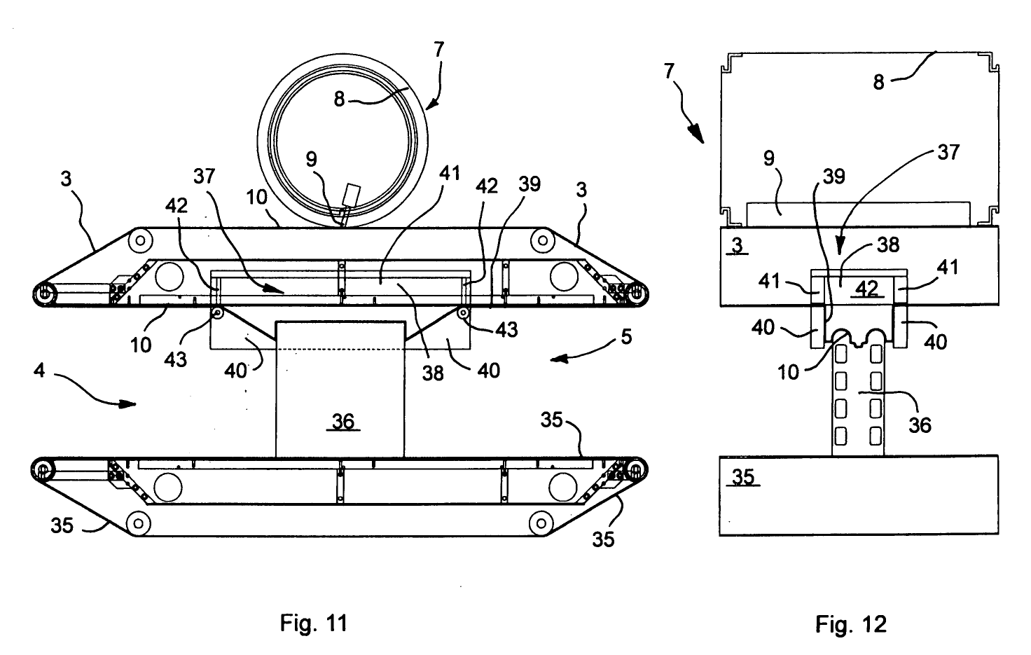

In a further embodiment, for tall materials to be decorated, FIGS. 11 and 12 illustrate a fifth embodiment of an intermittent machine provided with a conveyor belt 35 with intermittent motion synchronous with the step for generating an image on the surface 10 of a flexible upper tape 3, placed at a predetermined distance, for positioning the objects 36 from the loading 4 and unloading 5 areas to and from the decoration area 37. Similarly to the second embodiment, the image is transferred by applying pressure generated in a chamber 38 in the decoration area and on the back of the flexible upper tape 39. The chamber is composed of walls on the sides and an upper surface, while the lower surface is composed of the back 39 of the upper flexible tape 3. Below the tape 3 two tape-supporting sides 40 are placed near the longitudinal walls 41 of the chamber; in order to define the flexion area of the upper tape 3 rollers 43 are placed at the beginning and at the end, near the end walls 42 of the box, in such a way as to place the upper tape 3 close to said end walls, so as to minimize loss of compressed air.

When the object 36 is positioned in the decoration area 37, the respective positions of the conveyor belt 35 and the thin, elastic and flexible tape 3, can be greater than the correct decorating position in order to permit passage of the surface of the object to be decorated under the first roller 43, defining the lower surface of the chamber 38; in the same way, after the decoration step, the conveyor belt and tape can be repositioned so as to let the object move out of the decoration area, passing under the second roller 43; however the respective positions of the conveyor belt and the tape can be as shown with needing to move them around, i.e. between their support structures.

Decoration takes place by image generation similarly to the other embodiments, while for transfer, pressure is applied to the chamber 38 only with the object 36 in the central position of the decoration area 37. The pressure bends the upper flexible tape, making it adhere to the surface of the object, so that the image present on the surface 10 is placed in contact with the curved surface of the object to be decorated 36.

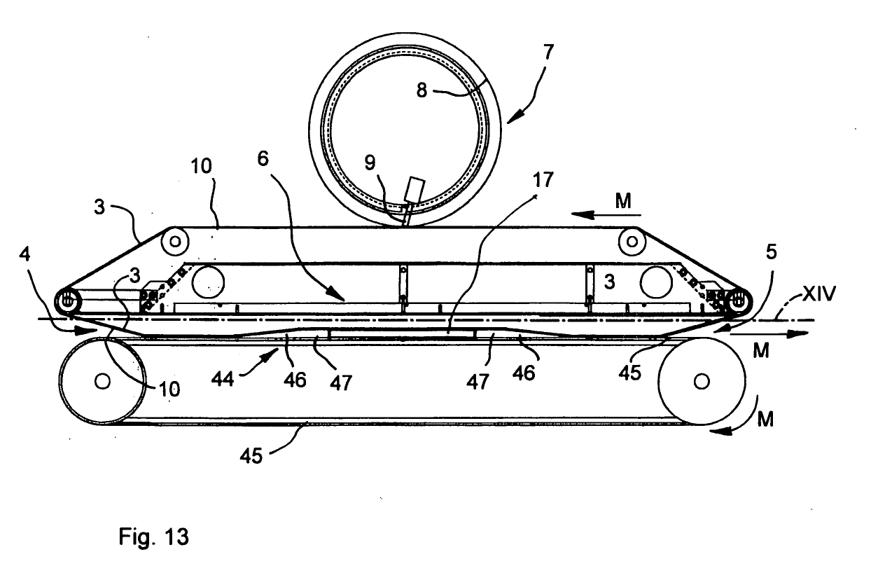

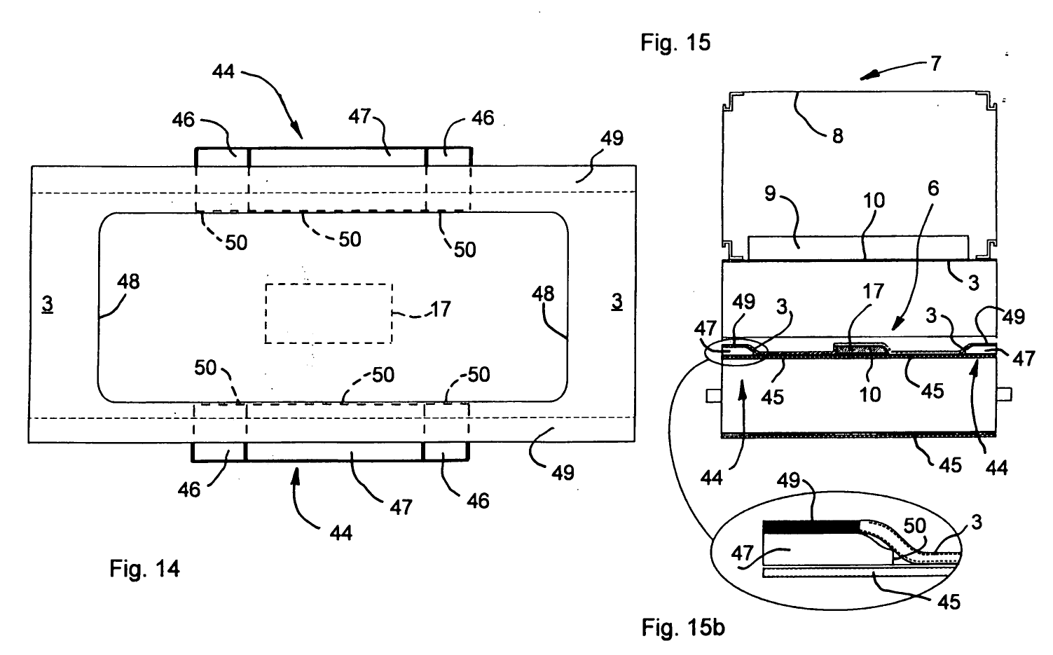

In a further embodiment variation, the sixth of the invention, shown in FIGS. 13, 14, 15 and 15b, to achieve the vacuum the machine is provided with a suction device with suction blades 44 which operates in the central decoration area 6, by suctioning the air between the upper tape 3 and lower conveyor belt 45 making the surface 10 of the flexible upper tape with the image to be transferred adhere to the object 17 to be decorated. The blades are advantageously placed on both sides, as shown in the Figures, and are provided with front and rear ramps 46, which are also used for suction, in the forward motion direction M of the conveyor belt, tape and object, to facilitate the insertion of the central section 47 of the suction blade between the conveyor belt and tape in synchronous motion. The suction in the decoration area 6 extends over a wide surrounding area 48 before and after said decoration area, as shown in FIG. 14. At least the upper tape 3 is provided with strips 49 on the lateral edges to reduce the friction of the tape sliding above the suction blades; furthermore, the suction blade is provided with suction mouths 50, distributed along the length, with a lower height in both the ramps 46 and in the central section 47.

In this embodiment, decoration takes place in the same way as in the previous embodiments, as also the lower conveyor belt 45 can be made of flexible material. The lower conveyor belt 45 in any case is advantageously provided with a differentiated structure with a plane for the object 17 to be decorated that is partially permeable to air so as to permit suction of the air around the object from the central area of the conveyor belt. The suction effect is extended over a wider surface of said decoration area, as indicated by reference 48 and the flexibility of the upper tape 3 in FIG. 13, which flexes much earlier and detaches much later after the start and release of the suction device 44 with the suction blade 46, 47.

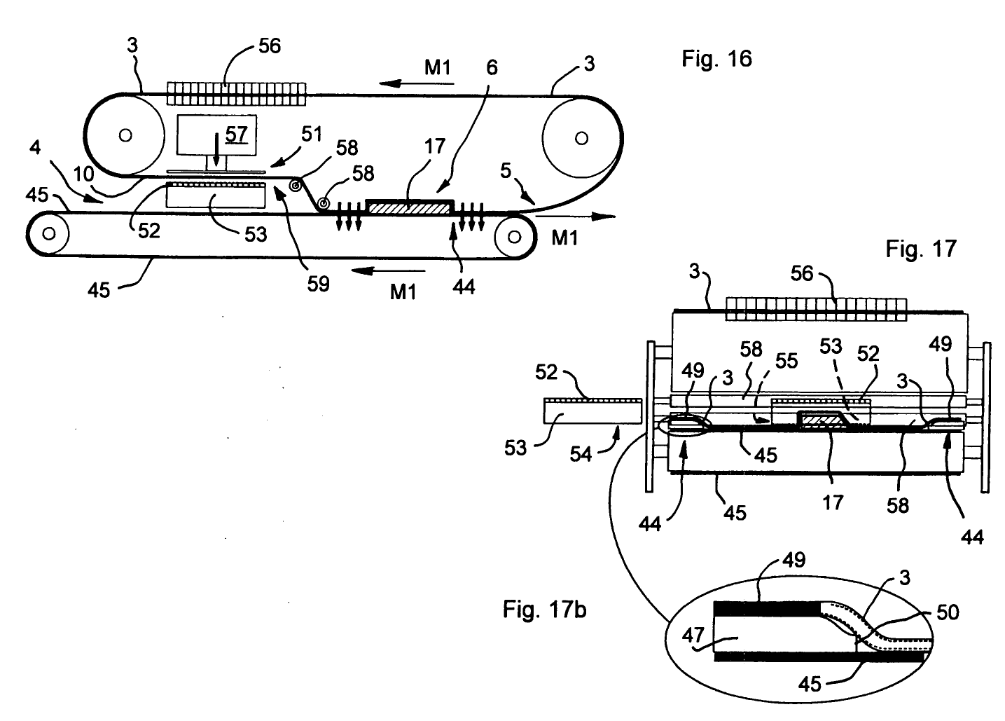

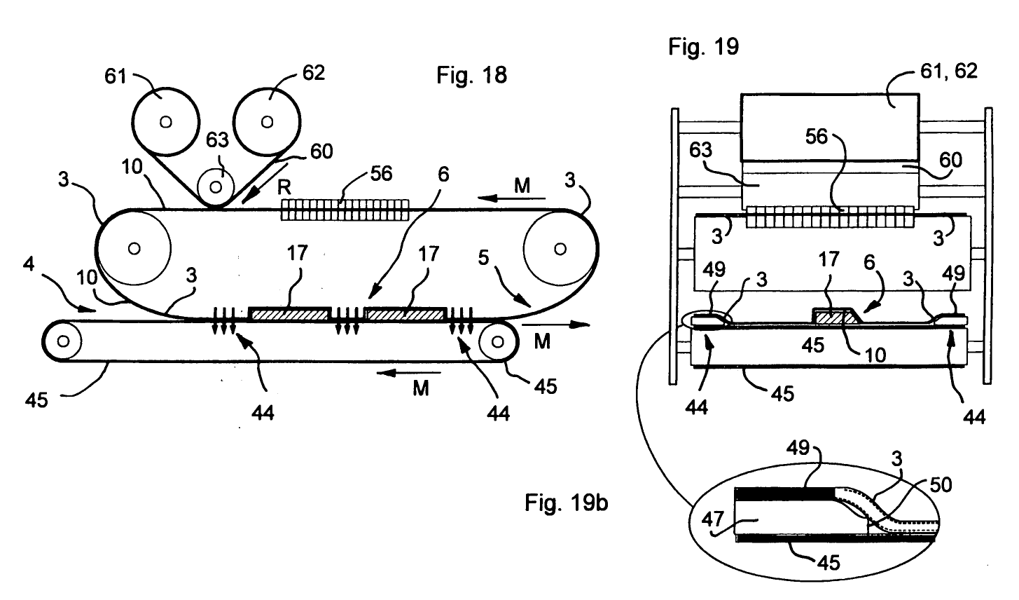

In an improved embodiment, a seventh and eighth machine embodiment of the invention is shown in FIGS. 16 to 19b, where other technical decoration means not mentioned in the previous embodiments are visible, with the flexible upper tape 3 and lower conveyor belt 45 in discontinuous or continuous forward motion, synchronously with the image generation step on the surface 10 of the upper tape 3, placed at a predetermined distance, so as to position the objects 17 from the loading 4 and unloading 5 areas to and from the decoration area 6 with movement of the objects, conveyor belt and tapes. Similarly to the sixth embodiment, application of the vacuum is provided by the suction device 44, while the image is formed and transferred with discontinuous cycles in the seventh embodiment, in FIGS. 16, 17 and 17b, or continuously as seen in FIGS. 18, 19 and 19b of the eighth embodiment, by means of the wax decalcomania procedure.

The discontinuous cycle decoration device 51 is provided with the decoration image transferred or generated on the surface 52, provided with a thin layer of wax for detaching it, the transfer container 53 from the external position 54 to the internal position 55, for moving the image from the container to the surface 10 of the tape 3; said tape is heated beforehand to the temperature necessary to melt the wax, by means of a heated plate 56, so as to make the image adhere to the tape 3. A linear actuator 57, by moving upwards or downwards, when the forward motion of the discontinuous cycle of the tape 3 is stopped, places the surface 10 of the flexible tape 3 into contact with it and then removes the image from the surface 52, where the heat from the tape surface melts the wax.

Subsequently the cycle continues with the movement of the container to the external position 54 to collect a further image from an image generation or transfer device from an image storage device on the surface 52 of the transfer container 53. Said image storage device can also be used as an image generation device directly on the waxed surface 52 of the container, of the known type with inkjet technology, otherwise known as printing. In this way it is possible to vary the image between subsequent prints, as this generation is controlled by computer as is known in the prior art.

During the transfer from one step to the next of the discontinuous decoration cycle, the tape 3 is moved forward so that the surface with the image 10 is placed in the decoration area 6. The movement of the tape with the image takes place between the stretching rollers 58 on the lower section 59 of the tape 3, to ensure the proper transfer of the image from the container underneath. During the discontinuous motion M1 the tape 3 moves forward by one step so as to transfer the tape with the image to the decoration area and the heated section of the tape 3 to the stretched lower section 59 of the tape. At the same time the conveyor belt 45 moves forward, bringing a new object 17 from the loading area 4 to the decoration area 6, where the suction device with suction blades 44 brings the flexible upper tape 3 with the image close to the object to be decorated 17. The motion of the object obviously takes place without the container 53 from the internal position 55 and, advantageously, with the lifting of the lower of the stretching rollers 58, or also without said lifting if the stretching roller is already higher than the minimum height required for the object to be able to pass through.

The image from the flexible tape in soft silicone 3 is detached from the tape by the pressure exerted by the vacuum created by the suction blade 46, 47 of the device 44 which is then transferred onto the object; the detachment from the soft silicone is ensured by the fact that the image material is less adherent to the silicone than to the material used for the object 17 to be decorated.

In the eighth embodiment, the flexible tape 3 is moved by continuous motion M that is synchronous with the conveyor belt 45 underneath; the images for decorating the objects 17 are collected in a storage device where a tape 60, stretched between the reels 61 and 62, releases the images in succession R due to the roller 63 being pressed against the surface 10 of the tape, which is heated beforehand by the plate 56. The conveyor belt and tape motion is continuous and therefore so is the motion of the objects 17 from the loading area 4 to the decoration area 6 and finally the unloading area 5. The operating speed, without the need for intervals for operations with alternated or intermittent motion, can reach high production capacities, therefore with very high decoration capacity. The decoration quality is very high thanks to the intrinsic precision of the decalcomania that contains the transferred image, which is advantageously of the wax type.

From tests carried out, a decoration apparatus with a soft silicone tape with a thickness of between 0.5 and 4 millimetres can easily decorate even greatly curved surfaces without breaking or cracking them, maintaining a long working life in the machine embodiments illustrated.

In brief, the present invention provides a new method for transferring images to even curved surfaces of objects to be decorated. Image generation takes place with a method known in the art on one surface of a tape in thin, elastic and flexible material, advantageously like soft silicone; the surface of the tape with the image subsequently adheres to the object to be decorated by means of the pressure of a fluid, advantageously air, which acts with a positive pressure on the back, with respect to the surface with the image, of the tape; the tape can be made to adhere also by the formation of a vacuum in the space under the surface of the tape bearing the image, in such a way that the atmospheric pressure acting on the back of said tape makes it adhere to the surface of the object to be decorated. In this way, through adhesion, the image is transferred to the surface of the object and the tape, when no longer subjected to pressure, returns to its original form. Adhesion is sufficiently rapid to obtain good quality of decoration. With this method also the object to be decorated is transported by a conveyor belt to the decoration area. This can therefore be carried out with a discontinuous or continuous cycle, depending on which of the methods is used for the generation and/or transfer of the image to be applied to the object on the tape, as the use of a tape for collecting and transferring the image and a conveyor belt for transporting the object to be decorated, with the specific characteristics described above, makes the cycle particularly fast and easy thanks to its continuous operation. Therefore a machine is provided for decorating objects with even very pronounced curved surfaces, simply and advantageously, as it can provide high production flexibility together with high quality of the image transferred, so as to permit high production capacities to be achieved, using the same machine.

The advantages in use are mainly expressed by the possibility, provided by the described image transfer method and machines, of carrying out precise decoration on curved surfaces, so as to obtain decoration almost identical to that of the flat surfaces of corresponding elements such as ceramic tiles and completion elements such as skirting boards, angular elements, edges, steps, as well as connecting elements between floor and wall. The decoration methods described can also make use of decoration means already used to decorate ceramic tiles, whether silkscreen rollers or curved surface rollers, or simply silkscreen or other image generation means known in the art, such as wax decalcomania, mentioned in the last two embodiments described, but which can also be applied to the previous embodiments.

The advantages in the use of the various embodiments can be identified by the specific characteristics of the single embodiments so as to satisfy the various requirements of production capacity which a user may require, from very low manual production to average or large serial production with the continuous operation machines described above. Moreover, a final advantage is the possibility of decorating even fragile objects so avoiding the mechanical stress, often resulting during production of single-fired objects, which the action of pressure can generate if contrasted with a rigid surface.

Naturally, in order to satisfy contingent and specific requirements, a person skilled in the art may apply to the above-described method and decoration machines with image transfer by pressure on a tape in thin, elastic and flexible material, described above, many modifications and variations, all of which, however, are included within the scope of protection of the present invention as defined by the following claims. In the same way, even if less advantageously, the flexible elastic material of which the tape is composed can be different from soft silicone, but similar in its characteristics of elasticity and strength. Moreover, even if not explicitly described, there can be combinations of the embodiments described above, where the composition or operating characteristics of one can be associated with those of the other embodiments described.

1. A machine for decorating objects having any shape whatsoever, comprising:
a decoration plane on which the object to be decorated is placed;
a decoration device with a component made of a thin, elastic and flexible material on which an image of the decoration is generated;
a pressure device for deforming said component in flexible material to make it adhere, together with the decoration of the image, to the curved surface of the object to be decorated, acting with greater pressure on the back of said component in flexible material with respect to the pressure applied to the surface with the image;
wherein the object to be decorated is transported on a conveyor belt into the machine from the loading area to the decoration area and then to the unloading area;
wherein the component in flexible material is a thin, elastic and flexible tape stretched over transport and rolling organs, is positioned at a short distance from the object to be decorated in the decoration area, and provides a surface, on which the image of the decoration to be applied has been generated or transferred;
wherein in the idle position said conveyor belt and tape are kept at a predetermined distance (D) which is greater than the maximum height of the objects to be decorated;
wherein the characterised in that decoration is carried out in the decoration area by air pressure being applied by a pressurising device to the back of the thin, elastic and flexible tape to deform it, and is complete when the deformation of the tape releases, and movements of the tape and conveyor belt are continuous or intermittent, and synchronous in such a way that flexion of the upper tape starts at the beginning of the decoration area and continues for its entire length such that the machine has continuously-fed production lines to decorate objects continuously.

2. The machine for decorating objects, according to claim 1, further comprising
a pressurising device composed of a chamber in the decoration area, of which the thin, elastic and flexible tape forms at least one wall,
wherein pressure is applied to the back of said tape, and said chamber is provided with lateral and longitudinal containment means for the deformed tape in order to minimise loss of the compressed air blown into the chamber pressurised in this way, and said chamber is composed of walls on the sides, two tape-supporting sides are placed near the longitudinal walls of the chamber; in order to define the flexion area of the upper tape rollers are placed at the beginning and at the end, near the end walls of a box, in such a way as to place the upper tape close to said end walls, and
the decoration cycle is intermittent to the object being introduced and stopped in the decoration area.

3. The machine for decorating objects, according to claim 1, further comprising:
a pressurising device composed of air suction organs around the object in the decoration area with suction capacity such as to deflect the thin, elastic and flexible tape so as to make it adhere, by means of the atmospheric pressure on the back of it, to the surface of the object to be decorated for the amount of time required for the cycle, if the cycle is discontinuous or intermittent, or for the time required for the object to pass through the decoration area if the decoration cycle is continuous, such that flexion of the upper tape starts at the beginning of the decoration area and continues for its entire length as vacuum application is released, whether the machine is being used with a discontinuous or continuous operation cycle.

4. The machine for decorating objects, according to claim 3, wherein the conveyor belt or at least one of its intermediary central strips is of semi-permeable material so as to permit air suction through said conveyor belt.

5. The machine for decorating objects, according to claim 3, wherein the conveyor belt comprises a tape in thin, elastic and flexible material, in which holes have been made near the centre of the tape, intended to correspond with the suction organs placed on the surface of the conveyor belt and around the decoration area, and
wherein the conveyor belt, in thin, elastic and flexible material, comprises a semi-permeable central strip to permit air suction at least within the width of the strip.

6. The machine for decorating objects, according to claim 3, wherein the conveyor belt comprises a tape in thin, elastic and flexible material, in which holes have been made, intended to correspond with the suction organs placed on the surface of the conveyor belt and around the decoration area, and
wherein the conveyor belt in thin, elastic and flexible material comprises several adjacent longitudinal rows of holes, to permit suction at least within the width of the strip occupied by the adjacent rows of holes.

7. The machine for decorating objects, according to claim 3, wherein the conveyor belt comprises a tape in thin, elastic and flexible material, with mobile suction organs placed between the tape and the conveyor belt and synchronous with them; moreover, the conveyor belt is in thin, elastic and flexible material with a semi-permeable central strip, to permit suction at least within the width of the strip, said suction organs being supported by a device to move them forward with the conveyor belt and tape and positioned with their suction end inside the semi-permeable central strip, between said conveyor belt and said tape in placed between the conveyor belt and the tape.

8. The machine for decorating objects, according to claim 3, wherein said suction organs are positioned between the conveyor belt and the tape and are supported by a device to move them forward with the conveyor belt and the tape, and are also positioned with the suction end near the decoration area; the forward movement device being composed of a vacuum-tight conveyor belt on pairs of pulleys at each end, which unites the ends of the suction organs outside the conveyor belt and tape and connects them to an internal space between the pulleys in order to apply a vacuum to said suction organs.

9. The machine for decorating objects, according to claim 8, characterised in that the vacuum is applied to the ends of the suction organs outside the tape controlled and regulated by a splitter septum which can be modified in the area where suction starts and ends, so as to apply or release suction as is necessary in said suction organs, in relation to the position they have reached compared to the decoration area of the objects.

10. The machine for decorating objects, according to claim 3, characterised in that it is further provided with the conveyor belt composed of a tape in thin, elastic and flexible material with suction organs placed between the conveyor belt and the tape; it is further provided with the conveyor belt in thin, elastic and flexible material with at least one semi-permeable central strip, to permit suction at least within the width of the strip; said suction organs being present on at least one side and positioned with the suction end on the edge of the semi-permeable central strip between said conveyor belt and said tape in thin, elastic and flexible material.

11. The machine for decorating objects, according to claim 10, characterised in that it is provided with said suction organs composed of a suction blade placed between the conveyor belt and the tape.

12. The machine for decorating objects, according to claim 11, characterised in that it is provided with the suction blade placed between the conveyor belt and the tape provided with front and rear ramps for insertion between the conveyor belt and the tape.

13. The machine for decorating objects, according to claim 10, further comprising:
a suction blade on each side placed between the conveyor belt and the tape.

14. The machine for decorating objects, according to claim 11, wherein at least the upper tape is provided with strips to reduce the friction of the tape sliding above the suction blades placed between the conveyor belt and the tape.

15. The machine for decorating objects, according to claim 3, further comprising:
a decoration device comprising organs for the generation or transfer of wax decalcomania that include a heated plate device for transfer to the thin, elastic and flexible tape.

16. The machine for decorating objects, according to claim 15, wherein said decoration device comprises containment organs that slide from an external position, for holding the image on a surface with a layer of wax, generated or transferred onto it, and an internal position, for transferring the image onto the thin, elastic and flexible tape.

17. The machine for decorating objects, according to claim 16, wherein said machine operates with discontinuous or intermittent operation cycles.

18. The machine for decorating objects, according to claim 15, wherein said decoration device comprises image storage and distribution organs provided with a tape with the images to be transferred, stretched between winding and unwinding reels, and pressed against the surface of the thin, elastic and flexible tape for the transfer of the image onto it.

19. The machine for decorating objects, according to claim 18, wherein said machine operates with continuous cycles.

20. A method for transferring images to curved surfaces of objects to be decorated, comprising
generation and/or transfer of the images, using the machine according to claim 1, onto the thin elastic and flexible intermediary transfer surface;
wherein the transfer surface comprises a thin, elastic and flexible tape which during the decoration process is placed at a short distance from the object to be decorated, and said thin, elastic and flexible tape provides the image made to adhere to the object to be decorated by means of overpressure of air applied to the back of it and therefore the surface with the image to be transferred,
wherein the object to be decorated moves synchronously on the conveyor belt with said thin, elastic and flexible tape discontinuously or continuously for generating the image, and the flexion of the upper tape starts at the beginning of the decoration area and continues for its entire length so to allow continuously-fed production lines to decorate the objects continuously.

21. The method according to claim 20 above, wherein the objects to be decorated are transported from the loading area to the decoration and unloading areas by the conveyor belt and the application of overpressure applied to the back of the thin, elastic and flexible tape is achieved by means of the suction organs that are placed between the conveyor belt and the tape.

22. The method according to claim 21 above, wherein the suction organs between the conveyor belt and the tape have motion synchronized with the conveyor belt and tape.

23. The method according to claim 21 above, characterised in that the suction organs between the conveyor belt and the tape are fixed to the frame of the machine.
